(19) United States
(12) Patent Application Publication
(10) Pub. No.: US 2024/0016103 A1
(43) Pub. Date: Jan. 18, 2024

(54) RAISED BORDER SYSTEM

(71) Applicants: VegHerb LLC, Wendell, NC (US); Guangdong Techwoodn Co., Ltd, ZhuHai city (CN)

(72) Inventor: Anthony Topping, Cary, NC (US)

(73) Assignees: VegHerb LLC, Wendell, NC (US); Guangdong Techwoodn Co., Ltd, ZhuHai city (CN)

(21) Appl. No.: 18/353,314

(22) Filed: Jul. 17, 2023

Related U.S. Application Data
(60) Provisional application No. 63/390,026, filed on Jul. 18, 2022.

(51) Int. Cl. A01G 9/28; A01G 9/12

(52) U.S. Cl. CPC A01G 9/28; A01G 9/124

(57) ABSTRACT

A raised border system includes a plurality of beams and a plurality of corner brackets that are configured to connect ends of the plurality of the beams to one another to form an enclosed inner area. Each corner bracket includes a first beam receiving slot that is open along a first side of the corner bracket and a second beam receiving slot that is open along a second side of the corner bracket and a first opening that is isolated from both the first beam receiving slot and the second beam receiving slot. The system includes a plurality of corner connectors that are coupled to and sit above the plurality of corner brackets. Each corner connector has an insert that is received within the first opening of one respective corner bracket. Each corner connector is configured to attach to an upper frame system.

### CROSS-REFERENCE TO RELATED PATENT APPLICATIONS

This application claims the priority of U.S. Provisional Patent Application 63/390,026, filed Jul. 18, 2022, which is incorporated by reference as if expressly set forth in its entirety herein.

### TECHNICAL FIELD

The present disclosure relates to the home gardening and landscape industry, and, in particular, a support device for constructing raised borders or beds suitable for use as landscape edging.

### BACKGROUND

Timber is used for building borders or walls on the ground to form edging for lawns and gardens. Generally, such edging systems comprise wooden beams and means for anchoring the wooden beams on the ground. However, current devices in the market do not provide a versatile raised border system which can be used to form a raised terrace bed or retaining wall of varying height without requiring extensive use of tools and physical effort to construct.

Frequently, consumers in the home gardening industry will use railroad ties to form landscape edges. However, the general problem with railroad ties is that they are costly, burdensome and once in place become difficult to remove. Further, due to the large weight and size of railroad ties, stacking them to create retaining walls may require excessive labor involving one or more parties and, as a result, be impractical. In addition, a separate means must be applied to anchor the railroad ties both to the ground and to one another.

It is desirable to thus provide a raised border system that is easy to assemble and is modular in nature in that it allows additional structures and accessories to be coupled thereto. For example, an upper frame system that can support different accessories can be coupled to the raised border system.

One type of upper accessory is a trellis. Garden vegetables and fruits can produce much higher yields when they are allowed to reach the plants' maximum height. For example, tomatoes, cucumbers, pole beans, squashes and many other vegetables may grow up to heights exceeding 8-10 feet and, in turn, will produce fruit proportionally. Although support devices for garden vegetables are well known, current devices in the market do not provide the area to support plants to this height, nor can these devices typically accommodate multiple plants on the same support device. Many support devices in the marketplace are not taller than six feet and do not enable the user to adjust the height of the device according to the desired type of plant or specific individual plant and vegetable needs. In addition, current gardening support devices generally lack the structural strength to support plants exceeding five feet in height.

It is therefore desirable to provide a raised border system that is easy to assemble and is modular in nature and allows for many different upper frame constructions, including greenhouse design, trellis design, etc.

### SUMMARY

A raised border system includes a plurality of beams and a plurality of corner brackets that are configured to connect ends of the plurality of the beams to one another to form an enclosed inner area. Each corner bracket includes a first beam receiving slot that is open along a first side of the corner bracket and a second beam receiving slot that is open along a second side of the corner bracket and a first opening that is isolated from both the first beam receiving slot and the second beam receiving slot. The system includes a plurality of corner connectors that are coupled to and sit above the plurality of corner brackets. Each corner connector has an insert that is received within the first opening of one respective corner bracket. Each corner connector is configured to attach to an upper frame system.

### BRIEF DESCRIPTION OF THE DRAWING FIGURES

FIG. 1 is an exploded perspective view of a raised border system according to one embodiment;

FIG. 2A is a perspective view of the raised border (bed) system of FIG. 1 in an assembled state;

FIG. 2B is a perspective view of an alternate raised border system in an assembled state

FIG. 3A is a perspective view of the raised border system of FIG. 1 in an assembled state with an upper frame system shown;

FIG. 3B is a perspective view of the raised border system of another embodiment in an assembled state with an upper frame system shown;

FIG. 4 is an exploded perspective view of a first corner connector for attachment to a corner bracket with a corner cap;

FIG. 5 is a perspective view of the first corner connector with a round pole extending therethrough;

FIG. 6 is a perspective view of a second corner connector with a square pole extending therethrough;

FIG. 7A is perspective view of a corner cover according to a first embodiment;

FIG. 7B is perspective view of a corner cover according to a second embodiment;

FIG. 7C is perspective view of a corner cover according to a third embodiment;

FIG. 7D is perspective view of a corner cover according to a fourth embodiment;

FIG. 7E is a top plan view of the corner bracket of FIG. 1;

FIG. 8 is a perspective view of a third corner connector;

FIG. 9 is a perspective view of the raised border system according to another embodiment in an assembled state showing an outer protective cover and an inner trellis:

FIG. 10 is a perspective view of one exemplary raised border system:

FIG. 11 is an exploded perspective view of components that form the raised border system in FIG. 10:

FIG. 12 is an exploded perspective view showing a first installation step for constructing the raised border system in FIG. 10;

FIG. 13 is an exploded perspective view of showing a second installation step for constructing the raised border system in FIG. 10;

FIG. 14 is a perspective view of one exemplary raised border system; and

FIG. 15 is a perspective view of another exemplary raised border system.

### DETAILED DESCRIPTION OF CERTAIN EMBODIMENTS

Illustrative embodiments of the invention will be described more fully hereinafter with reference to the accompanying drawings, in which some, but not all embodiments of the invention are shown. Indeed, the invention may be embodied in many different forms and should not be construed as being limited to the embodiments set forth herein; rather, these embodiments are provided so that this disclosure will satisfy applicable legal requirements. Like numbers refer to like elements throughout.

Raised/Elevated Border System

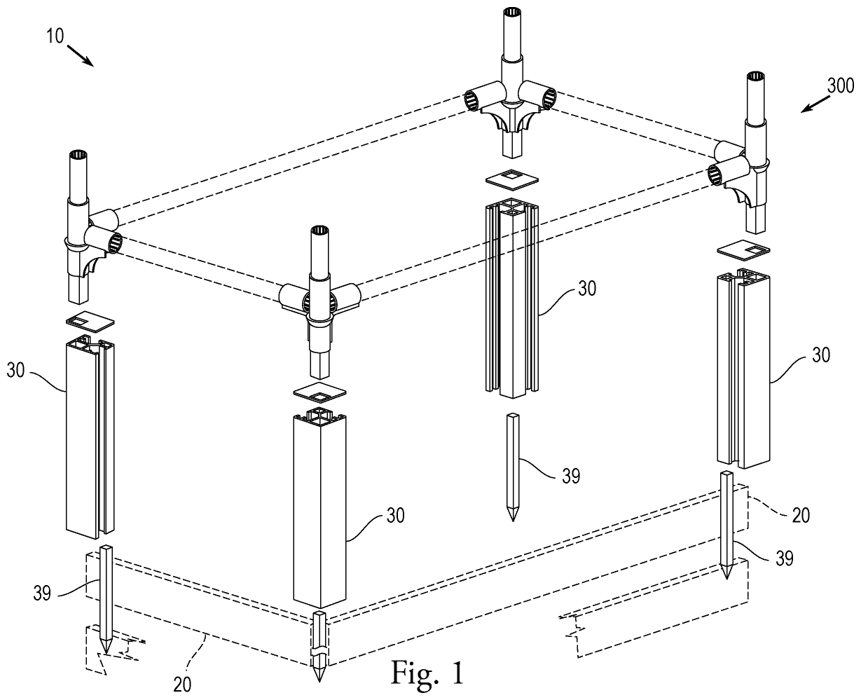

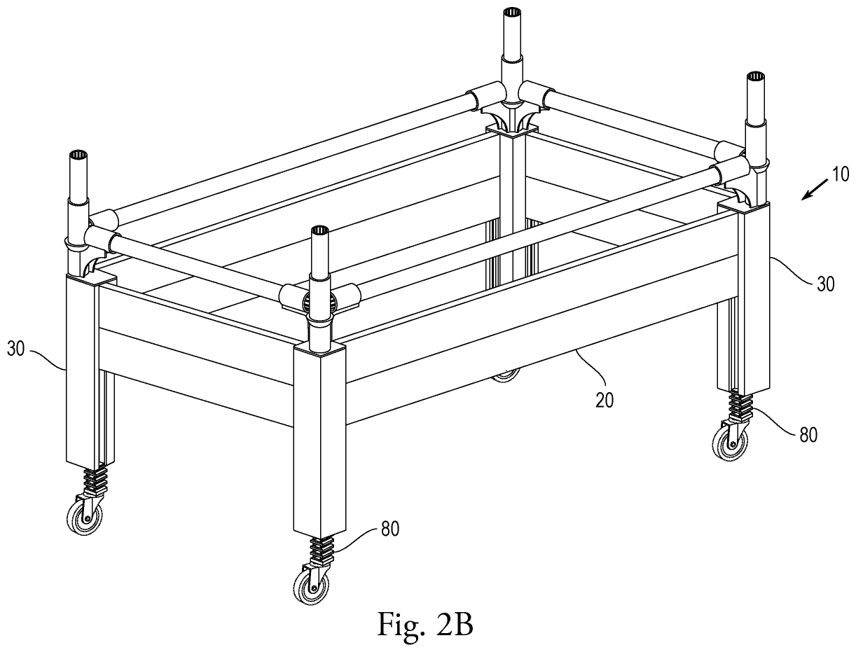

FIG. 1 illustrates a raised border system 10 according to the present invention consisting of a plurality of beams 20 and a plurality of corner brackets 30 that are configured to join the plurality of beams 20 to complete the raised border system 10. FIG. 3A shows a raised border system that is elevated relative to the ground, while FIG. 3B shows a border system that sits on the ground. It will be appreciated that the border system can be referred to as a raised border system or an elevated border system; however, for purposes of the present disclosure, the border system is referred to generically as a raised border system. It will also be appreciated that the expression “raised bed system” can be used interchangeably with “raised border system.”

Beam 20

The beam 20 can be made from an engineered material, preferably, a light rigid plastic, such as acrylonitrile-butadiene-styrene copolymer, polyethylene, polyvinyl chloride, polycarbonate, polypropylene or styrene. However, the beam can also be made from a natural material such as wood or any other strong, sturdy and weather resistant material, such as aluminum, fiberglass or galvanized metal. To form the raised border system 10, four beams 20 are used. If the raised border system 10 has a square shape, then the four beams 20 are identical and have the same lengths. However, as illustrated, if the raised border system 10 has a rectangular shape, then the four beams 20 consist of a first set of two that have a first length and a second set of two that have a second length that is greater than the first length. In this case, the first set of beams 20 is intended for use at the ends of the raised border system 10 and the second set of beams 20 is intended for use at the sides of the raised border system 10.

Each beam 20 thus has a top edge, an opposing bottom edge and two opposing ends. It will be appreciated that the heights of the beams 20 can vary depending upon the desired dimensions of the raised border system 10.

Corner Brackets 30

As mentioned, the corner brackets 30 are the parts that join the beams 20 to one another to form the assembled raised border system 10. The corner brackets 30 can be formed of any number of suitable materials including, but not limited to, metals, wood, plastics, etc.

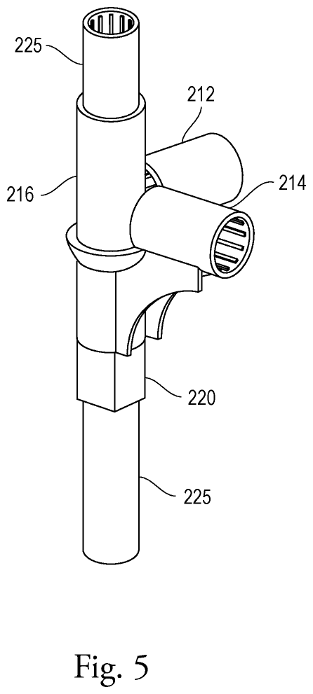

As shown best in FIG. 7E, each corner bracket 30 is a generally hollow structure that is made of a main body that has a first side wall 31, a second side wall 32, a third side wall 33, and a fourth side wall 34. The first side wall 31 and the second side wall 32 can be considered to be outer walls that face outward, while the third side wall 33 and the fourth side wall 34 can be considered to be inner walls that face inward. The third side wall 33 includes a first beam slot 35 and the fourth side wall 34 includes a second beam slot 36. The first beam slot 35 receives one beam, while the second beam slot 36 receives another beam. In the event that the raised border system 10 has a rectangular shape, the first beam slot 35 receives an end beam and the second beam slot 36 receives a side beam. The fit between the slots 35, 36 and the respective beams 20 is close or snug so that there is no undesired movement of the beams within the slots 35, 36. The beams 20 can be anchored and held within the slots 35, 36 using conventional techniques, including the use of fasteners that pass through the walls of the main body into the slots 35, 36 so that the fasteners can pass directly into the beams 20 themselves.

Another aspect of the main body of the corner bracket 30 is that it includes hollow closed spaces. In particular, the corner bracket 30 includes a first opening 38 and a second opening 39 spaced from the first opening 38. The first opening 38 can be considered to be an outer opening, while the second opening 39 can be considered to be an inner opening. As illustrated, the first and second openings 38, 39 have different sizes with the first opening 38 being larger than the second opening 39. The illustrated first and second openings 38, 39 have square shapes. The first opening 38 is thus located at the outer corner of the main body at the location at which the first side wall 31 and the second side wall 32 join one another. Conversely, the second opening 39 is thus located at the inner corner of the main body at the location at which the third side wall 33 and the fourth side wall 34 join one another.

Corner Caps

FIGS. 7A-7D illustrate corner caps that are intended to be coupled to and finish off the top of the corner bracket 30 (FIG. 7E).

FIG. 7A shows a first corner cap 40 that is completely solid. The first corner cap 40 closes off the open top of the corner bracket 30 and thus covers the top edges of the beams 20 and covers the first and second openings 38, 39. The first corner cap 40 has a square shape.

FIG. 7B shows a second corner cap 50. The second corner cap 50 closes off the open top of the corner bracket 30 and thus covers the top edges of the beams 20 and covers the second opening 39. However, the second corner cap 50 has an opening 52 formed therein that is oriented to be placed over the first opening 38 to provide direct communication to the first opening 38. The opening 52 is thus square shaped.

FIG. 7C shows a third corner cap 60. The third corner cap 60 closes off the open top of the corner bracket 30 and thus covers the top edges of the beams 20 and covers the first opening 38. However, the third corner cap 60 has an opening 62 formed therein that is oriented to be placed over the second opening 39 to provide direct communication to the second opening 39. The opening 62 is thus square shaped.

FIG. 7D shows a fourth corner cap 70. The fourth corner cap 70 closes off the open top of the corner bracket 30 and thus covers the top edges of the beams 20. However, the fourth corner cap 70 has a first opening 72 and a second opening 74 formed therein, with the first opening 72 oriented to be placed over the first opening 38 to provide direct communication to the first opening 38 and the second opening 74 oriented to be placed over the second opening 39 to provide direct communication to the second opening 39. The openings 72, 74 are thus square shaped.

It will be appreciated that the selection of the corner cap type is made in view of the overall design of the system and in particular is designed in view of whether one or more of the first and second openings 38, 39 are being used and are required to be accessible. Each of the corner caps provides a nice finish to the top of the corner bracket and closes it off to provide an aesthetically pleasing finish and prevents any debris from entering into the hollow structure.

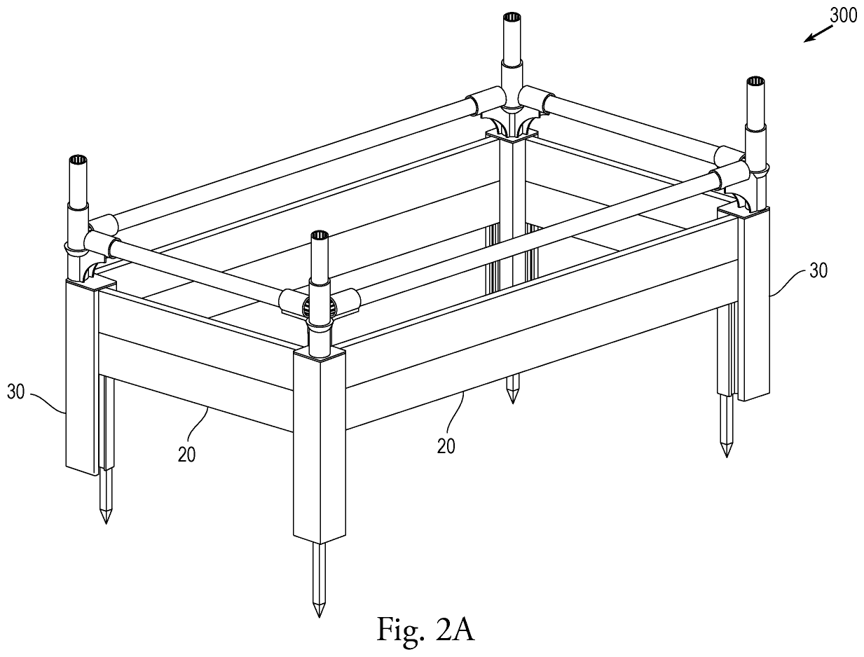

As shown in FIGS. 1 and 2, each corner bracket 30 can be secured to a stake 39 for staking the border frame system 10 into the ground. The stake 39 can have a cross-sectional shape that is complementary to the construction of the bracket 30. For example, the stake 39 can be constructed to be received in one of the openings 38, 39.

Construction and Assembly

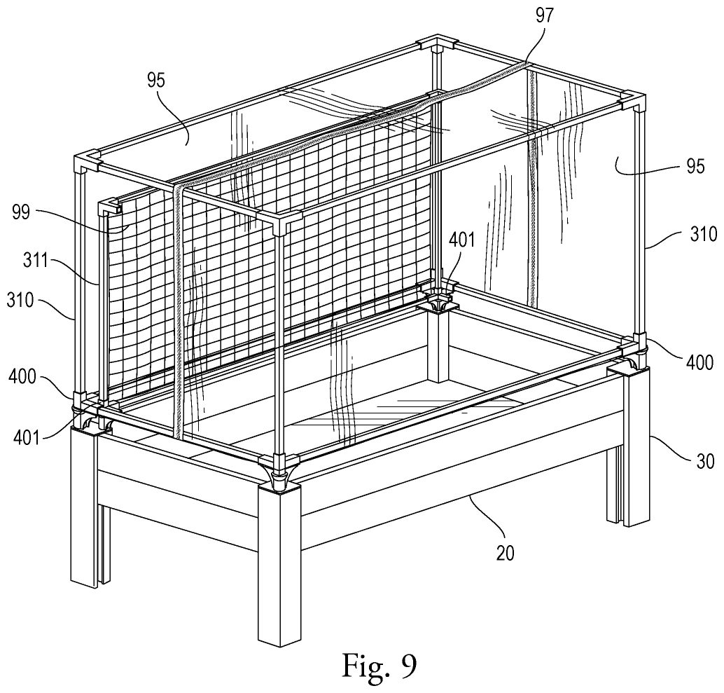

FIGS. 11-13 illustrate exemplary components and installation/assembly steps.

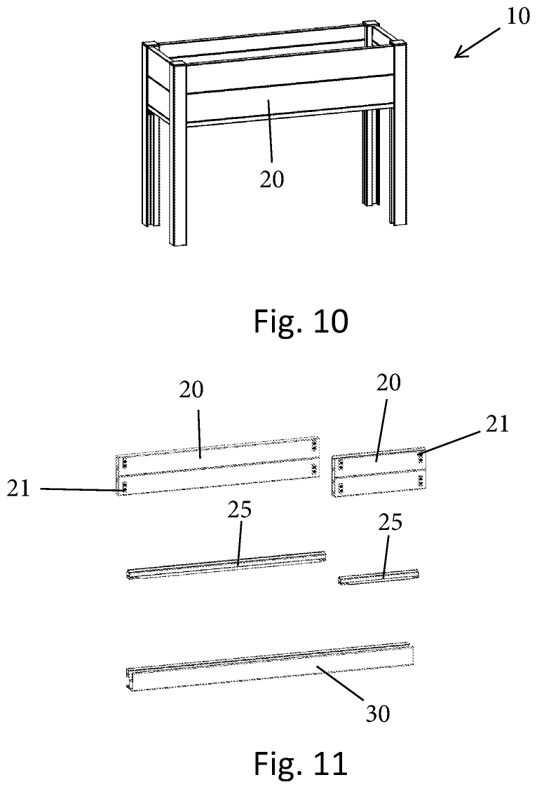

FIG. 11 is an exploded view of exemplary components that can be used to assemble the raised border system 10. Along an inner face of each beam 20, nubs 21 are provided. As shown, each end of the beam 20 contains one nub 21 which is used as a guide to position and couple the beam 20 to the corner bracket 30. A plurality of cross bars 25 are provided to provide a bottom frame to support the beams 20. It will be appreciated that the lengths of the cross bars 25 can vary depending on the size and shape of the raised border system. For example, for rectangular shaped raised border systems, a pair of long (side) cross bars 25 and a pair of short (end) cross bars 25 can be used. As shown in FIG. 12, a plurality of stops 29 are provided to fixedly located and support the cross bars 25. In particular, the stops 29 are received and fixed within one of the first beam slot 35 and the second beam slot 36. Each corner piece 30 thus includes one stop 29. The four stops 29 are positioned at the same heights. All stops 29 face inward toward the inside of the raised border system.

The stops 29 are thus located within the beam receiving slots and define the end of travel of the beams 20 within the slots. The stop 29 can be blocks or the like that are mounted within the slots using traditional means such as fasteners. As shown in FIG. 12, after the four stops 29 are fixed within the slots, ends of the cross bars 25 are fed into the respective beam receiving slots of the corner brackets 30. The cross bars 25 are lowered into the open top ends of the beam receiving slots and then lowered therein until the bottom most cross bar 25 contacts the respective stops 29. The cross bars 25 are thus supported by the stops 29.

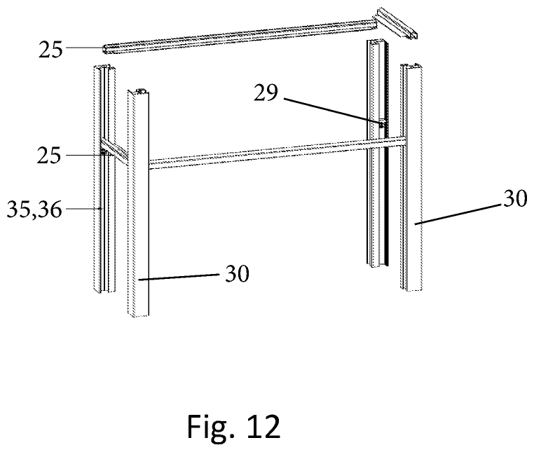

The cross bars 25 can have upward facing grooves that are configured to receive the beams 20. As shown in FIG. 13, the beams 20 are lowered into the open top ends of the beam receiving slots and slide within these slots until the beams 20 seat against the cross bears 25. The bottom most beam 20 can be received within the groove of the cross bar 25 and this coupling improves the connection between these parts. The nubs 21 disposed along the inner face of each beam 20 also provides a manner by which the beam 20 is coupled to the frame in that the nubs 21 slide within the beam receiving slots. More specifically, within each beam receiving slot there is a channel (e.g., C or U-shaped channel) in which the nub 21 is received and slides to provide additional securement of the beam. The side walls of the raised border system is thus constructed by a series of steps in which the structural elements are inserted into and slide within the beam receiving slots.

Caster/Wheels

FIG. 2B shows the use of casters (wheels) 80 that are attached to the corner brackets 30. Each caster 80 has a square shaped leg that is received within one of the openings 38, 39 to couple the caster 80 to one corner bracket 30. The installation of four casters 80 allows the raised border system to be movable.

Additional Configurations

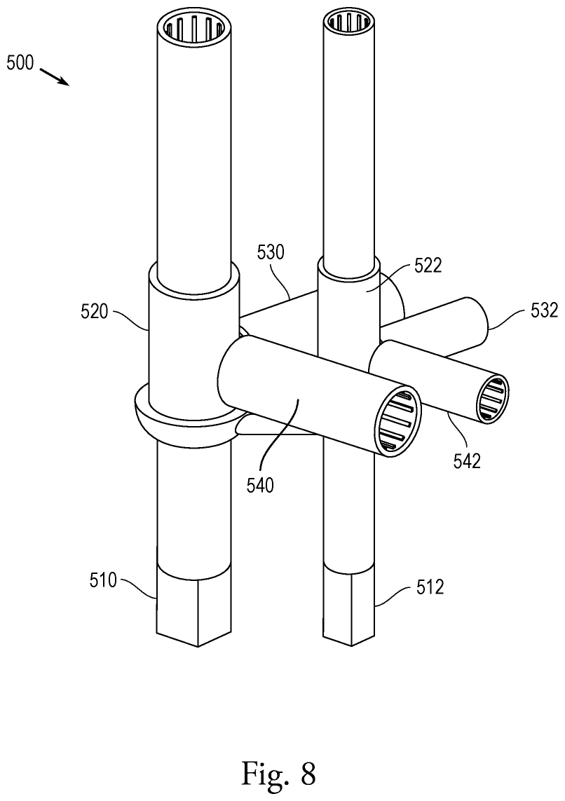

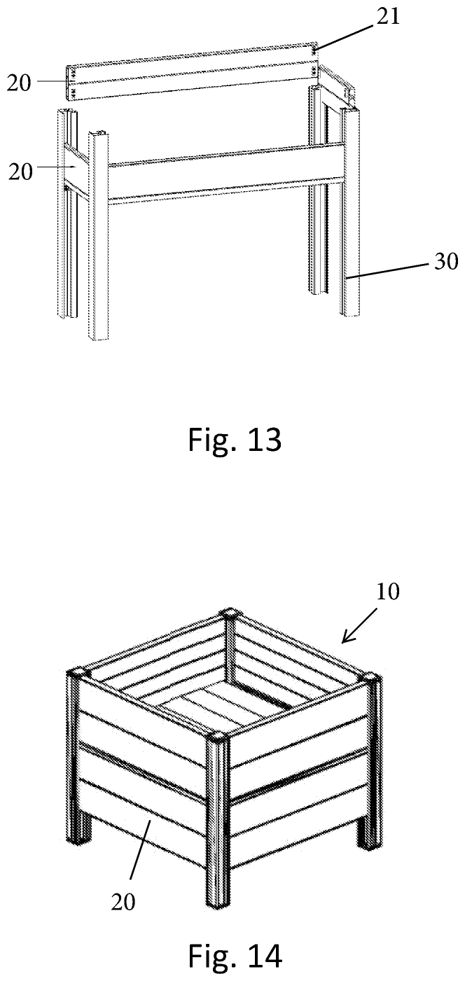

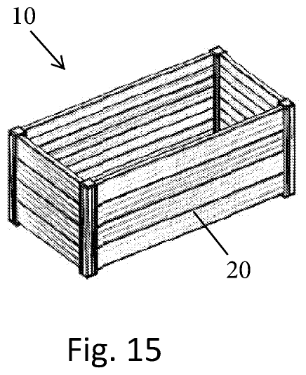

FIGS. 10, 14 and 15 illustrate that the raised border system 10 can be formed to have different shapes and sizes. For example, the raised border system 10 can have a square shape or rectangular shape. In addition, the number and layers of beams 20 used to form the raised border system 10 can vary. FIG. 10 shows a rectangular shape with two layers of beams 20. FIG. 14 shows a floor planter. FIG. 15 shows a rectangular shape with four layers of beams 20 (each side wall is formed of four stacked beams 20).

Upper Frame and Upper Frame Accessories

In one exemplary embodiment, the upper frame 300 can be a modified upper frame based on the teachings set forth in U.S. Pat. No. 6,311,428, which is hereby expressly incorporated by reference in its entirety.

In general terms, the upper frame 300 can consist of a plurality of vertical supports 310 that are located in the corners; a plurality of lower side cross pieces 320; a plurality of lower end cross pieces 330; a plurality of upper side cross pieces 340; and an upper end cross pieces 350. The lower side cross pieces 320 and the upper side cross pieces 340 are parallel to one another and similarly, the lower end cross pieces 330 and the upper end cross pieces 350 are parallel to one another. When the raised border system 10 has a rectangular shape, the upper frame 300 has a rectangular shape as well. The upper and lower side cross pieces 320, 340 have lengths that are greater than the lengths of the upper and lower end cross pieces 330, 350.

As described herein, each of the vertical supports 310; the lower side cross pieces 320; the lower end cross pieces 330; the upper side cross pieces 340; and the upper end cross pieces 350 can join to connectors/brackets in the four corners of the upper frame 300 and the raised border system 10. Alternatively, FIG. 3A shows the upper end cross pieces 350 and the upper side cross pieces 340 being part of an integral structure.

In one embodiment, each vertical support 310, 311 can have an upper section and a lower section interconnected in telescoping fashion, such as to provide a simple but durable means for adjusting the height of the extendable trellis.

In one embodiment, the upper section can comprise two identical upper side rails connected to an upper cross piece. Each upper side rail can be a C-shaped defining a channel along its vertical axis, has a top portion, a bottom portion and is of the similar shape and configuration along its entire length. At the distal ends of the upper cross piece, the top portion of each side rail is perpendicularly fastened using a fastening means to form the upper section of the extendable garden trellis, such that the resulting upper section is in the shape of a half rectangle or inverted “u.” In one embodiment, the fastening means is a molded fastening bracket incorporated into the top portion of the upper side rail. Thus, the fastening bracket and upper side rail are a single unit. The fastening bracket of the upper side rail has a top leg perpendicular to the vertical axis of the upper cross piece. Exemplary fastening brackets are disclosed in U.S. Pat. No. 6,311,428.

The lower section can comprise two identical lower side rails connected to the lower cross piece. Each lower side rail can be C-shaped, defining an interior channel along its vertical axis, a top portion and a bottom portion. In one embodiment, the length of each side rail is 3-6 feet, while the width is 0.5-2.5 inches, depending on the size and strength desired. The lower side rails may be made from molded synthetic plastic. They may, however, be constructed from any light weight, rust resistant rigid material, such as aluminum, fiberglass or galvanized metal. The lower cross piece can be made of the same material and is similar in shape and width as each of the lower side rails. Further, the lower cross piece can be of the same size, shape, configuration and length as the upper cross piece.

Corner Connectors

In accordance with one aspect of the present system, the raised border system 10 is designed to be coupled to the upper frame system 300 by a plurality of corner connectors that are configured to engage and be securely attached to the raised border system 10.

### Corner Connector (First Embodiment)

FIGS. 1-5 illustrate a first corner connector 200 according to a first embodiment. It will be appreciated that the in the case of the rectangular shaped raised border system 10 that includes four corners, four first corner connectors 200 are used. In other words, each corner of the raised border system 10 includes one first corner connector 200 that engages the respective corner bracket 30 of the raised border system 10.

The first corner connector 200 includes a main body 210 that has a bottom insert 220 that is configured to be inserted into one of the openings 38, 39 of the corner bracket 30. As mentioned above, each of the illustrated openings 38, 39 has a square shape and thus, the bottom insert 220 has a complementary square shape. In the illustrated embodiment, as mentioned above, the two square shaped openings 38, 39 have different sizes with the outer square shaped opening 38 having greater dimensions (width) than the inner square shaped opening 39. Thus, the sizing of the bottom insert 220 is selected in view of the intent of being received within one of the square shaped openings 38, 39. In other words, if the bottom insert 220 is intended to be received within the larger outer square shaped opening 38, then it will have larger dimensions than when the bottom insert 220 is intended to be received within the smaller inner square shaped opening 39.

The width of the bottom insert 220 is equal to or substantially equal to the width of the corresponding opening 38, 39 to allow a friction fit or close fit between the two parts. The reception of the bottom insert 220 into one of the square openings 38, 39 couples the first corner connector 200 to the corner bracket 30.

The bottom insert 220 is formed along a first axis.

The main body 210 of the first corner connector 200 also includes a number of legs that receive structural support members of the frame to allow construction and assembly of the upper frame system 300. The main body 210 includes a first leg 212 formed along a second axis and a second leg 214 that is formed along a third axis. The second and third axes are perpendicular to one another. The second and third axes are perpendicular to the first axis along which the bottom insert 220 is formed.

In one embodiment, the first leg 212 receives one end of one lower end cross piece 330 or one end of one lower side cross piece 340, while the second leg 214 receives one end of one lower end cross piece 330 or one end of one lower side cross piece 340. These parts can be assembled and held together with a friction fit and/or can include additional connecting techniques, such as use of fasteners and/or locking members.

The main body 210 also includes an upper leg 216 that is also formed along the first axis. The axis of the bottom insert 220 is thus coincident to the axis of the upper leg 216. The first and second legs 212, 214 are thus formed perpendicular to the upper leg 216.

In the illustrated embodiment, the first leg 212, the second leg 214, and the upper leg 216 have cross-sections that are different than the bottom insert 220. More specifically, the bottom insert 220, as mentioned, has a square shape, while each of the first leg 212, the second leg 214 and the upper leg 216 has a circular cross-section shape.

Each of the bottom insert 220, the first leg 212, the second leg 214, and the upper leg 216 is hollow.

The first corner connector 200 can be securely attached to the corner bracket 30 by any number of different techniques. For example, a friction fit can be used and to provide further securement, a set screw can be used that passes through the side of the corner bracket 30 into one of the square shaped openings 38, 39 and into the bottom insert 220. This set screw provides an additional attachment point between the two parts.

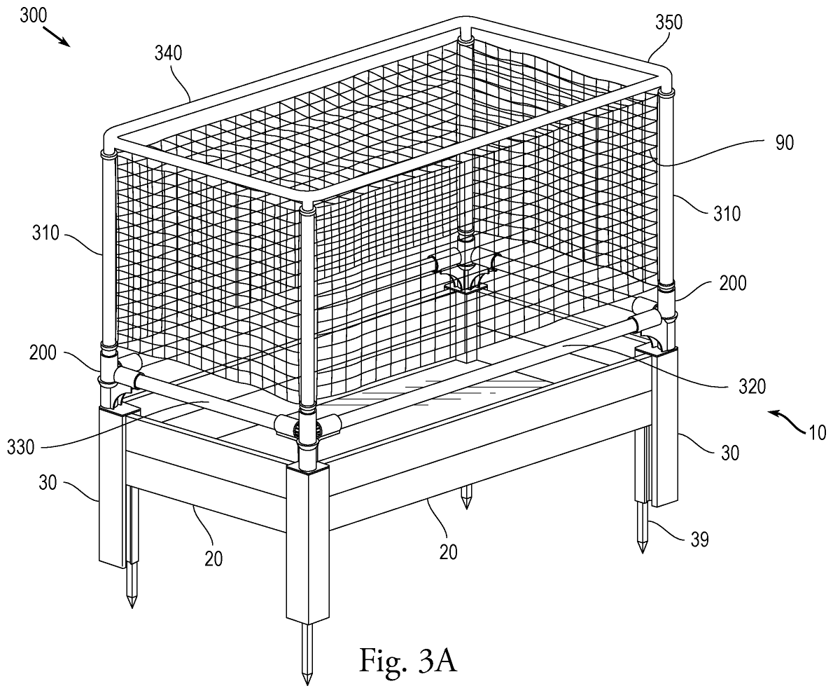

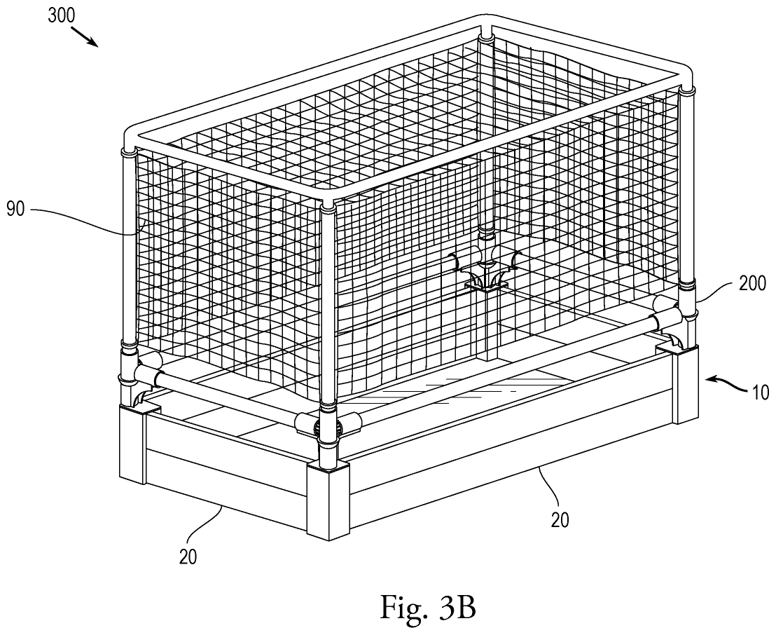

As shown in FIGS. 4 and 5, another technique is to use a connector pole 225 that is configured to extend along the first axis and in particular, passes through the upper leg 216, through the main body 210, and through the bottom insert 220. It will be appreciated that a set screw, such as the one described above, can be anchored to the connector pole 225 as by passing through the corner bracket 30 and the bottom insert 220. The connector pole 225 can serve as the vertical support member (e.g., vertical support 310) in each corner of the upper frame system 300. The connector pole 225 can have a circular cross-section.

### Corner Connector (Second Embodiment)

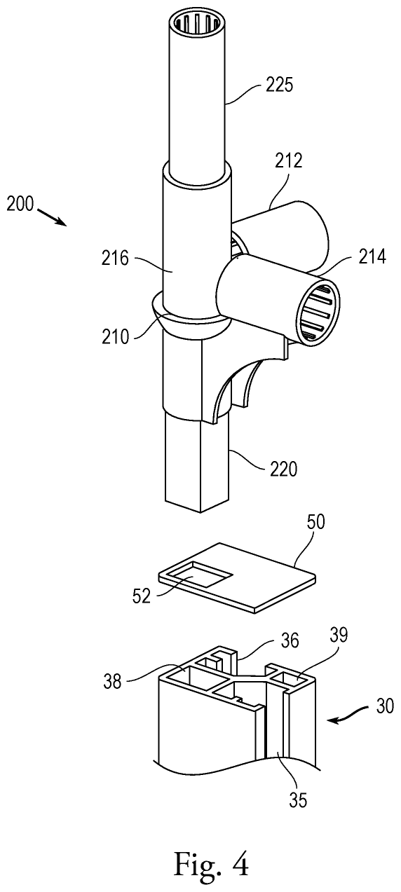

FIG. 6 illustrates a second corner connector 400 according to a second embodiment. It will be appreciated that the in the case of the rectangular shaped raised border system 10 that includes four corners, four second corner connectors 400 are used. In other words, each corner of the raised border system 10 (FIG. 1) includes one second corner connector 400 that engages the respective corner bracket 30 of the raised border system 10.

The second corner connector 400 includes a main body 410 that has a bottom insert 420 that is configured to be inserted into one of the openings 38, 39 of the corner bracket 30. As mentioned above, each of the illustrated openings 38, 39 has a square shape and thus, the bottom insert 420 has a complementary square shape. In the illustrated embodiment, as mentioned above, the two square shaped openings 38, 39 have different sizes with the outer square shaped opening 38 having greater dimensions (width) than the inner square shaped opening 39. Thus, the sizing of the bottom insert 420 is selected in view of the intent of being received within one of the square shaped openings 38, 39. In other words, if the bottom insert 420 is intended to be received within the larger outer square shaped opening 38, then it will have larger dimensions than when the bottom insert 420 is intended to be received within the smaller inner square shaped opening 39.

The width of the bottom insert 420 is equal to or substantially equal to the width of the corresponding opening 38, 39 to allow a friction fit or close fit between the two parts. The reception of the bottom insert 420 into one of the square openings 38, 39 couples the second corner connector 400 to the corner bracket 30.

The bottom insert 420 is formed along a first axis.

The main body 410 of the second corner connector 400 also includes a number of legs that receive structural support members of the frame to allow construction and assembly of the upper frame system 300. The main body 410 includes a first leg 412 formed along a second axis and a second leg 414 that is formed along a third axis. The second and third axes are perpendicular to one another. The second and third axes are perpendicular to the first axis along which the bottom insert 420 is formed.

In one embodiment, the first leg 412 receives one end of one lower end cross piece 330, while the second leg 414 receives one end of one lower side cross piece 340. These parts can be assembled and held together with a friction fit and/or can include additional connecting techniques, such as use of fasteners and/or locking members.

The main body 410 also includes an upper leg 416 that is also formed along the first axis. The axis of the bottom insert 420 is thus coincident to the axis of the upper leg 416. The first and second legs 412, 414 are thus formed perpendicular to the upper leg 416.

In the illustrated embodiment, the first leg 412, the second leg 414, and the upper leg 416 have cross-sections that are the same as the bottom insert 420. More specifically, the bottom insert 420, as mentioned, has a square shape, and similarly, each of the first leg 412, the second leg 414 and the upper leg 416 has a square cross-section shape.

Each of the bottom insert 420, the first leg 412, the second leg 414, and the upper leg 416 is hollow.

The second corner connector 400 can be securely attached to the corner bracket 30 by any number of different techniques. For example, a friction fit can be used and to provide further securement, a set screw can be used that passes through the side of the corner bracket 30 into one of the square shaped openings 38, 39 and into the bottom insert 420. This set screw provides an additional attachment point between the two parts.

As shown in FIG. 6, another technique is to use a connector pole 425 that is configured to extend along the first axis and in particular, passes through the upper leg 416, through the main body 410, and through the bottom insert 420. It will be appreciated that a set screw, such as the one described above, can be anchored to the connector pole 425 as by passing through the corner bracket 30 and the bottom insert 420. The connector pole 425 can serve as the vertical support member (e.g., vertical support 310) in each corner of the upper frame system 300. The connector pole 425 has a square cross-section.

### Corner Connector (Third Embodiment)

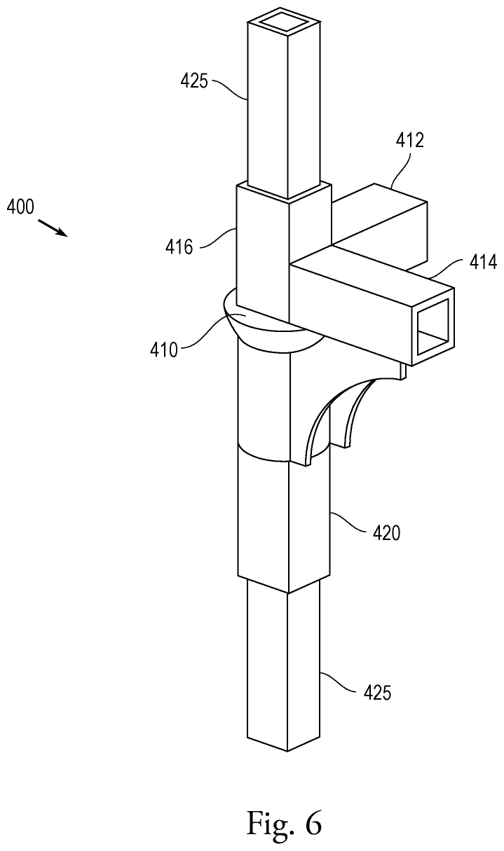

FIG. 8 illustrates a third corner connector 500 according to a third embodiment. It will be appreciated that the in the case of the rectangular shaped raised border system 10 that includes four corners, four second corner connectors 500 are used. In other words, each corner of the raised border system 10 includes one second corner connector 500 that engages the respective corner bracket 30 of the raised border system 10.

Unlike the other corner connectors, the third corner connector 500 is designed to engage and mate with both the first and second openings 38, 39 and thus includes two bottom inserts 510, 512 that are received within the respective first and second openings 38, 39. The main body of the third corner connector 500 includes two upper legs 520, 522 that are spaced apart from one another. The axes of the two bottom inserts 510, 512 and the two upper legs 520, 522 are parallel to one another. By having two upper legs 520, 522 as part of a single integral connector body, a more complex upper frame assembly can be provided and in particular, a double upper frame system is provided. More specifically, the double upper frame system includes an inner upper frame system that engages the second (inner) openings 39 and an outer upper frame system that engages the first (outer) openings 38.

Similarly, the third corner connector can have two first legs 530, 532 and two second legs 540, 542. The first leg 530 and second leg 540 are part of the outer upper frame system, while the first leg 532 and the second leg 542 are part of the inner upper frame system.

In a double upper frame system, the two different upper frame systems can be used for two different purposes. For example, the outer upper frame can be used to provide the main upper frame structure that can support main outer cover 90 and lighting or the like and the inner upper frame can be used to provide a trellis structure. For example, U.S. Pat. No. 8,919,041, which is hereby expressly incorporated by reference in its entirety, discloses suitable lighting systems that can be used in the present raised bed border system.

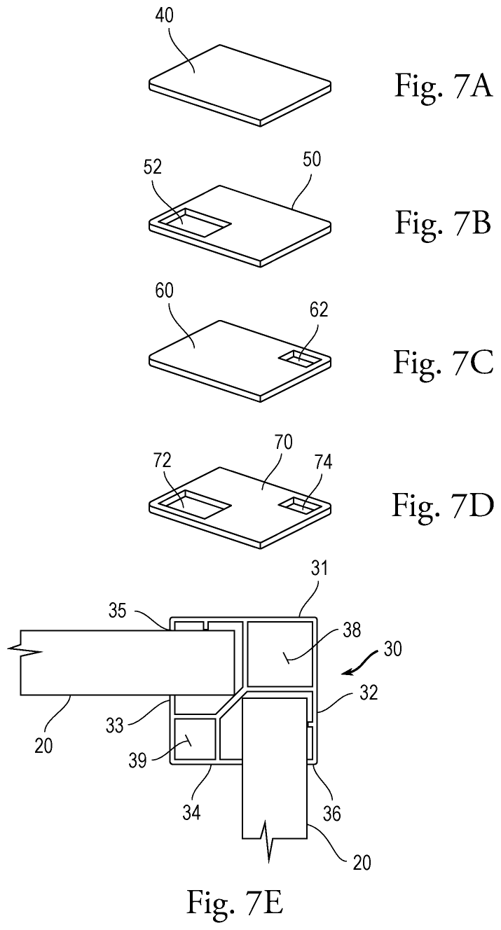

FIG. 3A shows the outer cover 90 be in the form of netting. However, it will be appreciated that the outer cover 90 is not limited to being netting but instead can be in the form of an outer panels (e.g., sheets or film) (FIG. 9), such as a transparent PVC film or a very fine mesh or a fabric material. FIG. 9 shows a four walled outer panel structure with a roof panel. It will be appreciated that one or more of these wall panels can include additional features, such as vents, etc. In addition, an access point, such as zipper 97, can be provided in one or more outer panels to allow access.

Dual Frame Arrangement (FIG. 9)

FIG. 9 shows a dual frame arrangement in which there is an outer frame that includes an outer upper frame that includes the vertical supports 310. The outer upper frame supports the outer panels or cover 95. In the illustrated embodiment, the outer panels 95 can be in the form of transparent PVC sheets (alternatively it can be form of a fabric or mesh, etc.). Zipper 97 provides an access point for the inside. The outer upper frame includes outer connectors (i.e., second corner connectors 400) that are inserted into the outer openings 38.

FIG. 9 also shows an inner frame that is contained within the outer frame within the outer panels 95. The inner frame can include inner corner connectors 401 that are very similar to the second corner connectors 400 with the exception that they are designed to be received within the inner openings 39. The inner corner connectors 401 support the vertical supports 311 that are the same as or similar to vertical supports 311 but are located internal to vertical supports 310. The inner frame supports a trellis 99 which is in the form of netting or the like. In the illustrated embodiment, the trellis 99 is only formed along one side in that the trellis 99 is located along one outer panel 95. It will be appreciated that the inner frame can support an object other than a trellis.

It is to be understood that like numerals in the drawings represent like elements through the several figures, and that not all components and/or steps described and illustrated with reference to the figures are required for all embodiments or arrangements.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presences of stated features, integers, steps, operations, elements, and/or components, but do not preclude the presence or addition of one or more other features, integers, steps, operations, elements, components, and/or groups thereof.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

The subject matter described above is provided by way of illustration only and should not be construed as limiting. Various modifications and changes can be made to the subject matter described herein without following the example embodiments and applications illustrated and described, and without departing from the true spirit and scope of the present invention, which is set forth in the following claims.

What is claimed is:

1. A raised border system comprising:
a plurality of beams;
a plurality of corner brackets that are configured to connect ends of the plurality of the beams to one another to form an enclosed inner area, each corner bracket including a first beam receiving slot that is open along a first side of the corner bracket and a second beam receiving slot that is open along a second side of the corner bracket and a first opening that is isolated from both the first beam receiving slot and the second beam receiving slot; and
a plurality of corner connectors that are coupled to and sit above the plurality of corner brackets, each corner connector having an insert that is received within the first opening of one respective corner bracket, each corner connector being configured to attach to an upper frame system.

2. The raised border system of claim 1, wherein the raised border system has one of a square shape and a rectangle shape.

3. The raised border system of claim 1, wherein each beam comprises an elongated structure that has an inner face, the inner face of each beam having a pair of nubs that are configured to be received within a guide channel formed within one of the first beam receiving slot and the second beam receiving slot for coupling and guiding insertion and travel of the beam within one of the first beam receiving slot and the second beam receiving slot.

4. The raised border system of claim 1, wherein the guide channel is in communication with the respective one of the first beam receiving slot and the second beam receiving slot.

5. The raised border system of claim 1, where each corner connector has a main body with the insert extending downwardly from the main body, the main body including an upper leg for attachment to the upper frame system and a pair of side legs for attachment to cross supports of the upper frame system.

6. The raised border system of claim 5, wherein the pair of side legs are formed 90 degrees apart from one another.

7. The raised border system of claim 5, wherein the upper leg and the insert are coaxial to one another.

8. The raised border system of claim 5, wherein the upper leg and pair of side legs each has a cross-sectional shape selected from the group consisting of a circle and a square.

9. The raised border system of claim 1, wherein the first opening is square shaped and the insert has a square shaped cross-section.

10. The raised border system of claim 1, wherein the first opening comprises a through hole that extends completely from a top edge to a bottom edge of the corner connector.

11. The raised border system of claim 1, wherein the corner connector includes a second opening that is isolated from each of the first opening, the first beam receiving slot and the second beam receiving slot.

12. The raised border system of claim 11, wherein dimensions of the second opening are different than dimensions of the first opening.

13. The raised border system of claim 12, wherein the second opening has smaller dimensions than the first opening.

14. The raised border system of claim 11, wherein the first opening is located in an outer corner at an intersection between third and fourth sides of the corner bracket and the second opening is positioned internal to the first opening and is located in an inner corner at an intersection between the first and second sides of the corner bracket.

15. The raised border system of claim 1, further including: a plurality of stops that are fixed within one of the first beam receiving slot and the second beam receiving slot; and a plurality of cross pieces that are received within one of the first beam receiving slot and the second beam receiving slot, the plurality of cross pieces being supported by the plurality of stops and be configured to support the plurality of beams.

16. The raised border system of claim 1, further including a plurality of corner caps that are configured to be coupled to and cover a top edge of the corner brackets, the corner cap including a first aperture that is aligned with and defines an entrance into the first opening of the corner bracket.

17. The raised border system of claim 1, wherein the corner connector includes a second opening that is isolated from each of the first opening, the first beam receiving slot and the second beam receiving slot and the system further includes a plurality of corner caps that are configured to be coupled to and cover a top edge of the corner brackets, the corner cap including a first aperture that is aligned with and defines an entrance into the first opening of the corner bracket and a second aperture that is aligned with and defined an entrance into the second opening of the corner bracket.

18. The raised border system of claim 5, wherein the inserts are hollow and the system further includes a plurality of poles that pass through the upper legs and through the inserts into the first openings of the corners brackets.

19. A corner connector kit for use with a raised border system that includes a plurality of beams, the corner connector kit comprising:
a plurality of corner brackets that are configured to connect ends of the plurality of the beams to one another to form an enclosed inner area, each corner bracket including a first beam receiving slot that is open along a first side of the corner bracket, a second beam receiving slot that is open along a second side of the corner bracket and a first opening that is isolated from both the first beam receiving slot and the second beam receiving slot; and
a plurality of corner connectors that are coupled to and sit above the plurality of corner brackets, each corner connector having an insert that is received within the first opening of one respective corner bracket, each corner connector being configured to attach to an upper frame system.

20. A raised border system comprising:
a plurality of beams;
a plurality of corner brackets that are configured to connect ends of the plurality of the beams to one another to form an enclosed inner area, each corner bracket including: (a) a first beam receiving slot that is open along a first side of the corner bracket; (b) a second beam receiving slot that is open along a second side of the corner bracket; (c) a first opening that is isolated from both the first beam receiving slot and the second beam receiving slot; and (d)) a second opening that is isolated from both the first beam receiving slot, the second beam receiving slot and the first opening, wherein the first opening is located in an outer corner of the corner bracket and the second opening is located in an inner corner of the corner bracket;
a plurality of first corner connectors that are coupled to and sit above the plurality of corner brackets, each first corner connector having a first insert that is received within the first opening of one respective corner bracket, each first corner connector being configured to attach to an upper outer frame system; and
a plurality of second corner connectors that are coupled to and sit above the plurality of corner brackets, each second corner connector having a second insert that is received within the second opening of one respective corner bracket, each first corner connector being configured to attach to an upper inner frame system, wherein the plurality of second corner connectors are disposed internal to the plurality of first corner connectors.

21. The raised border system of claim 20, wherein the upper outer frame system includes a plurality of outer panels that enclose the inner area and the upper inner frame system comprises a trellis frame.

22. The raised border system of claim 21, wherein the outer panels are selected from the group consisting of: plastic panels, netting, and fabric panels.

23. The raised border system of claim 22, wherein the outer panels comprise transparent PVC panels.

24. The raised border system of claim 21, wherein the trellis frame extends along less than all of the outer panels of the upper outer frame system.
